(19) United States
(12) Patent Application Publication
(10) Pub. No.: US 2008/0255291 A1
(43) Pub. Date: Oct. 16, 2008

(54) Large Particle, High Mineral Purity Calcined Kaolins And Methods Of Preparing And Using Same

(75) Inventors: Edward J. Sare, Macon, GA (US); Tommy L. Adkins, Cochran, GA (US)

Correspondence Address: FINNEGAN, HENDERSON, FARABOW, GARRETT & DUNNER;LLP, 901 NEW YORK AVENUE, NW, WASHINGTON, DC, 20001-4413, US

(73) Assignee: Imerys Kaolin, Inc., Dry Branch, GA (US)

(21) Appl. No.: 12/066,261

(22) PCT Filed: Aug. 28, 2006
(86) PCT No.: PCT/US06/33775

§ 371 Date: Mar. 8, 2008

Related U.S. Application Data
(60) Provisional application No. 60/714,900, filed on Sep. 8, 2005.

(51) Int. Cl. C08K 3/34; C09D 1/00; C04B 33/04; C01B 33/26

(52) U.S. Cl. 524/447; 106/286.5; 423/328.1; 501/141

(57) ABSTRACT

Disclosed herein are compositions comprising novel calcined kaolins having a large particle size and low levels of alkali and alkali earth metal oxides. Methods of making the disclosed calcined kaolin by calcining hydrous kaolin are described. Applications using the disclosed compositions in preparing catalyst substrates, paints, coatings, sealants, cementitious products, ceramics, rubbers, polymers and other compositions are also described.

This application claims priority to U.S. Provisional Patent Application No. 60/714,900, filed on Sep. 8, 2005.

Disclosed herein are compositions comprising novel calcined kaolins having a large particle size and low levels of alkali and alkali earth metal oxide compounds. Methods of making these compositions and their uses are also disclosed.

Kaolin is a white industrial mineral comprising aluminosilicates, which has found use in a wide range of applications, such as catalyst substrates, paints, paper coating compositions, sealants, cementitious products, ceramics, rubbers, polymers and other compositions. Large deposits of kaolin clay exist in Devon and Cornwall England, Brazil, China, Australia and in the states of Georgia and South Carolina in the United States of America.

Particulate kaolins occur naturally in the hydrous form and exist as crystalline structures containing hydroxyl functionality. These hydrous kaolins may contain other mineral components, such as alkali and alkali-earth metal oxides. Alkali metal oxides include, but are not limited to, sodium oxide (Na₂O) and potassium oxide (K₂O).

Particulate kaolins may be converted to a calcined form by thermal processes. Such processes cause the particulate kaolin to at least partially dehydroxylate. During calcination, the hydrous kaolin converts from a crystalline to an amorphous form. Further, during calcination, aggregation typically occurs. Other mineral components present in the hydrous kaolin are thus incorporated into the calcined kaolin.

Because the minerals present in hydrous kaolin are not removed during calcination, conventional calcined kaolin may further comprise impurities such as talc, halloysite, calcium carbonate, gypsum, feldspar, silica, and nepheline syenite among other components, along with unconverted hydrous kaolin. Some of these naturally occurring impurities include alkali and alkali-earth metal oxides, and compositions comprising conventional calcined kaolin can include an alkali and alkali-earth metal oxide content of 2% by weight or greater, such as at least about 5% by weight, relative to the total weight of the calcined kaolin.

However, these levels of alkali and alkali earth metal oxides can have a deleterious effect in some applications, such as, for example, in the case of catalyst substrates used in catalytic converters wherein excess alkali metal contamination can cause at least one of decreasing the number of NO₂ adsorption sites, increasing the coefficient of thermal expansion (where the catalytic converter is a ceramic), and generally weakening the structural properties of the ceramic. Furthermore, the ability of catalyst substrates to effectively function in catalytic converters may depend in part on the particle size of the catalyst substrate. Therefore, a need exists for improved catalyst substrate materials for catalytic converters.

### BRIEF DESCRIPTION OF THE DRAWINGS

FIG. 1 is a graph plotting the particle size (x-axis, μm) vs. the percentage of particles by weight below the noted particle size (y-axis) of inventive sample A in Example 1, as determined by a Microtrac Model X100 Particle Size Analyzer.

FIG. 2 is a graph plotting the particle size (x-axis, μm) vs. the percentage of particles by weight below the noted particle size (y-axis) of inventive sample B in Example 1, as determined by a Microtrac Model X100 Particle Size Analyzer.

FIG. 3 is a graph plotting the particle size (x-axis, μm) vs. the percentage of particles by weight below the noted particle size (y-axis) of inventive sample C in Example 1 as determined by a Microtrac Model X100 Particle Size Analyzer.

FIG. 4 is a graph plotting the particle size (x-axis, μm) vs. the percentage of particles by weight below the noted particle size (y-axis) of inventive sample D in Example 1 as determined by a Microtrac Model X100 Particle Size Analyzer.

Disclosed herein is a composition comprising a calcined kaolin having a relatively large mean particle size (d₅₀), such as at least about 2 μm, the calcined kaolin having a low content of alkali and/or alkali earth metal oxides, such as a Na₂O content of less than about 1% by weight, relative to the total weight of the calcined kaolin.

Also disclosed is a composition comprising a calcined kaolin having a particle size distribution, wherein less than about 25% of the particles have a particle size less than about 1 μm, the calcined kaolin having a low content of alkali and/or alkali earth metal oxides, such as a Na₂O content of less than about 1% by weight, relative to the total weight of the calcined kaolin.

Also disclosed is a method of preparing a disclosed composition, wherein the method comprises heating the hydrous kaolin to at least one temperature ranging from about 500° C. to about 1200° C. for a time sufficient to at least partially dehydroxylate the hydrous kaolin.

A disclosed method of forming a ceramic body may comprise

1) combining a calcined kaolin with at least one compound selected from alumina, talc and aluminum hydroxide,

2) adding an amount of water and mixing to form a clay comprising the calcined kaolin, and

3) extruding the clay to form the ceramic body.

Another method of forming a ceramic body is also disclosed. This method may comprise

a) adding a liquid medium to the disclosed composition to form a calcined kaolin slurry;

b) flocculating the calcined kaolin slurry;

c) dewatering the calcined kaolin slurry to obtain a calcined kaolin wet cake; and

d) forming the calcined kaolin wet cake into a ceramic body.

Disclosed herein is a method of forming a ceramic body comprising using a dry calcined kaolin having a mean particle size (d₅₀) of at least about 2 μm, the calcined kaolin having a Na₂O content of less than about 1% by weight, relative to the total weight of the calcined kaolin, to cast the ceramic body.

One embodiment of the present disclosure provides a composition comprising a calcined kaolin having a mean particle size (d₅₀) of at least about 2 μm, the calcined kaolin having a Na₂O content of less than about 1% by weight, relative to the total weight of the calcined kaolin.

In one embodiment, the phrase “having a mean particle size (d₅₀) of at least about 2 μm” refers to a d₅₀ as determined using Sedigraph, unless another method of particle size determination is specified. In one embodiment, particle sizes, and other particle size properties referred to in the present disclosure, are determined using a SEDIGRAPH 5100 instrument as supplied by Micromeritics Corporation. The size of a given particle is expressed in terms of the diameter of a sphere of equivalent diameter, which sediments through the suspension, i.e., an equivalent spherical diameter or esd. The mean particle size, or the d₅₀ value, is the value of the particle esd at which there are 50% by weight of the particles, which have an esd less than that d₅₀ value.

All particle size data measured, determined and reported herein, including in the examples, were taken in a known manner, with measurements made in water at the standard temperature of 34.9° C. All percentages and amounts expressed herein are by weight. All amounts, percentages, and ranges expressed herein are approximate.

In one embodiment, particle sizes and other particle size properties are determined from a mass distribution of particles. A mass distribution of particles refers to the percentage of particles having a given mass across a range of mass amounts. Unless otherwise indicated, particle size and other particle size properties are determined from a mass distribution of particles using Sedigraph.

In another embodiment, particle sizes, and other particle size properties referred to in the present disclosure, are determined from a number distribution of particles. A number distribution of particles refers to the percentage of particles below a given particle size across a range of particle sizes. In one embodiment, particle size and other particle size properties are determined by a Microtrac Model X100 Particle Size Analyzer, as supplied by Microtrac. The Microtrac analysis determines particle size based on the number distribution of particles using a laser light scattering technique.

In some embodiments, the particle size as determined by SEDIGRAPH 5100 may not be the same as that determined by a Microtrac Model X100 Particle Size Analyzer. The difference may be due to the different methods used by each instrument to determine the particle size. The SEDIGRAPH 5100 measures the sedimentation of particles over time, whereas the Microtrac Model X100 Particle Size Analyzer analyzes a laser light scattering pattern using a specific algorithm.

In one embodiment, the d₅₀ of the calcined kaolin as determined from the mass distribution of particles, e.g., Sedigraph 5100, is at least about 2 μm, such as at least about 3 μm, at least about 4 μm, at least about 5 μm, at least about 10 μm, at least about 15 μm, or at least about 20 μm.

In another embodiment, the d₅₀ of the calcined kaolin as determined from, for example, the number distribution of particles, e.g., Microtrac Model X100 Particle Size Analyzer, is at least about 7 μm, such as at least about 9 μm, or at least about 12 μm.

In another embodiment, less than about 25% of the particles by weight have a d₅₀ less than about 1 μm, relative to the total weight of the composition.

In one embodiment, the Na₂O content of the calcined kaolin is less than about 0.6% by weight, such as less than about 0.5% by weight, less than about 0.1% by weight, or less than about 0.05% by weight, relative to the total weight of the calcined kaolin.

“Calcined kaolin,” as used herein refers to a kaolin that has been converted from the corresponding (naturally occurring) hydrous kaolin to the dehydroxylated form by thermal methods. Calcination is effected by heat-treating coarse or fine hydrous kaolin in a known manner, e.g., at temperatures ranging from 500° C. to about 1200° C., such as temperatures ranging from about 800° C. to about 1200° C., about 900° C. to about 1100° C., or about 1000° C. to about 100° C. In one embodiment, the hydrous kaolin is heat-treated at 1050° C.

The degree to which hydrous kaolin undergoes changes in crystalline form can depend upon the amount of heat to which the hydrous kaolin is subjected. Initially, dehydroxylation of the hydrous kaolin can occur upon exposure to heat. At temperatures below a maximum of about 850-900° C., the product is often considered to be virtually dehydroxylated, with the resultant amorphous structure commonly referred to as a metakaolin. Frequently, calcination at this temperature is referred to “partial calcination,” and the product may also be referred to as “partially calcined kaolin.” Further heating to temperatures above about 900-950° C. can result in further structural changes, such as densification. Calcination at these higher temperatures is commonly referred to as “full calcination,” and the product is a calcined kaolin, commonly referred to as ‘fully calcined kaolin’. In one embodiment, the calcined kaolin is a fully calcined kaolin.

“Calcined” (or “calcination”), as used in herein, may encompass any degree of calcination, including partial (meta) and/or full and/or flash calcination. Effective calcining procedures include, but are not limited to, soak calcining and flash calcining. In soak calcining, a hydrous kaolin is heat treated at temperatures ranging from about 500° C. to about 1200° C., such as temperatures ranging from about 800° C. to about 1200° C., or temperatures having a maximum of at least about 850-900° C., or temperatures of at least about 900-950° C., as described herein, for a period of time (e.g., from at least several minutes to 5 or more hours) sufficient to dehydroxylate the kaolin. In flash calcining, a hydrous kaolin is heated rapidly for a period of less than about 1 second, typically less than about 0.5 second at the temperatures described herein.

The furnace, kiln, or other heating apparatus used to effect calcining of the hydrous kaolin may be of any known kind. Known devices suitable for carrying out soak calcining include high temperature ovens, rotary kilns, and vertical kilns. Known devices for effecting flash calcining include toroidal fluid flow heating devices, such as those described in WO 99/24360, the disclosure of such devices is incorporated by reference herein.

If the calcined kaolin is further heated, a portion of the calcined kaolin may be converted to the mullite phase. Thus, in some cases the calcined kaolin can comprise a high mullite content, such as for example greater than 2% mullite, greater than 5% mullite or greater than 10% mullite by weight relative to the total weight of the calcined kaolin. Mullite concentrations ranging from about 2% to about 40% by weight may be useful in some end-use applications, such as ceramic catalyst substrates, e.g., cordierite substrates.

Generally, the properties of both hydrous kaolin and calcined kaolin are dependent on attributes, such as particle size (expressed in terms of mean particle size, d₅₀), shape, and texture of the individual particles and of agglomerates thereof.

In one embodiment, the content of alkali and alkali-earth metal oxides, along with other oxides and elements, in the calcined kaolin can be determined as a percentage by weight, relative to the total weight of the calcined kaolin. The content was determined by X-ray fluorescence spectroscopy using a Bruker SRS 3000 X-Ray Fluorescence Spectrometer. In one embodiment, the calcined kaolin has a combined content of Na₂O, K₂O, MgO, and CaO that is less than about 1% by weight, such as less than 0.7% by weight, less than about 0.5% by weight, or less than 3% by weight, relative to the total weight of the calcined kaolin. In one embodiment, the calcined kaolin has a K₂O content less than about 0.5% by weight, such as less than about 0.25% by weight, relative to the total weight of the calcined kaolin. In another embodiment, the calcined kaolin has a Fe₂O₃ content less than about 1% by weight, such as less than about 0.5% by weight, relative to the total weight of the calcined kaolin. In one embodiment, the calcined kaolin has a TiO₂ content less than about 2% by weight, such as less than about 1% by weight, relative to the total weight of the calcined kaolin.

The particle size distribution of the calcined kaolin may be unimodal or multimodal, such as bimodal. Modality refers to the concentration of particles of a given size over a range of sizes, determined herein using, for example, a SEDIGRAPH 5100 or a Microtrac Model X100 Particle Size Analyzer. Unimodal distributions have a single mean particle size, whereas multimodal distributions exhibit at least 2 distinguishable components (or modes) based on particle size. In one embodiment, the calcined kaolin particle size distribution is unimodal, having a mean particle size greater than about 2 μm. In another embodiment, the calcined kaolin particle size distribution is multimodal, such as bimodal, wherein the particle size distribution exhibits at least two distinguishable modes.

In one embodiment, one distinguishable mode corresponds to a mean particle size of at least about 2 μm, such as at least about 3 μm, or at least about 4 μm, and another distinguishable mode corresponds to a mean particle size of less than about 2 μm, such as less than about 1 μm, or less than about 0.5 μm.

Calcined kaolin products typically include a small percentage of particles that can have undesirable effects when used in ceramics and can cause blockage of the die in extrusion processes. These particles may be retained on a 325 mesh screen. One embodiment of the present disclosure includes a composition comprising the disclosed calcined kaolin wherein an amount of residue in the calcined kaolin that is retained by a 325 mesh screen is less than about 1% by weight, such as less than about 0.6% by weight, less than about 0.1% by weight, or less than about 0.05% by weight, relative to the total weight of the calcined kaolin.

Oil absorption refers to the number of grams of oil absorbed by 100 grams of the calcined kaolin (units of g/g, indicated as a %) and is traditionally considered to be an indication of the total resin demand of the calcined kaolin. A greater oil absorption may lead to an increase in the total resin demand of compositions comprising the calcined kaolin, such as paint compositions, which can lead to, for example, increased opacity in high PVC paints. Oil absorption is dependent on particle structure, interparticle packing, and particle size. One technique to determine oil absorption is the Spatula Rub-out Oil Absorption Test (ASTM D-281). One embodiment of the present disclosure provides a composition comprising the disclosed calcined kaolin wherein the calcined kaolin has an oil absorption of at least about 40%, such as at least about 50%, at least about 60%, or at least about 70%.

The brightness of calcined kaolins is given as the GE brightness. GE brightness is a unitless reflectance percentage value measured in a well known manner by a Technibrite TB-1C instrument. In one embodiment, the brightness of the composition comprising the disclosed calcined kaolin is at least about 70%, such as at least about 80%.

One embodiment of the present disclosure provides a composition comprising a calcined kaolin having a particle size distribution, wherein less than about 25% of the particles have a particle size less than about 1 μm, the calcined kaolin having a Na₂O content of less than about 1% by weight, relative to the total weight of the calcined kaolin. In one embodiment, the calcined kaolin has less than about 10%, such as less than about 5%, or less than about 3% of particles having a particle size less than about 1 μm. In another embodiment, less than about 25% of the particles have a particle size less than about 0.5 μm.

Another embodiment of the present disclosure provides a method of preparing a composition comprising:

heating a hydrous kaolin having a Na₂O content of less than about 1% by weight, relative to the total weight of the hydrous kaolin, to at least one temperature ranging from about 500° C. to about 1200° C. for a time sufficient to at least partially dehydroxylate the hydrous kaolin. In one embodiment, the composition thus prepared comprises an at least partially calcined kaolin having a mean particle size (d₅₀) of at least about 2 μm, the calcined kaolin having a Na₂O content of less than about 1% by weight, relative to the total weight of the calcined kaolin.

In one embodiment, the heating occurs for a time sufficient to fully dehydroxylate the hydrous kaolin. The method may form partially calcined kaolin or fully calcined kaolin. The method used for calcination may be, for example, soak calcining or flash calcining.

Calcined kaolins having a coarse particle size can be useful in paint compositions. Accordingly, another aspect of the present disclosure provides a paint composition comprising any of the calcined kaolin compositions described herein. In one embodiment, the paint comprises a composition comprising a calcined kaolin having a mean particle size (d₅₀) of at least about 2 μm, the calcined kaolin having a Na₂O content of less than about 1% by weight, relative to the total weight of the calcined kaolin. In another embodiment, the paint can further comprise at least one thickener present in an amount effective to stabilize the paint. In one embodiment, the amount of thickener ranges from about 1 pound to about 10 pounds thickener per 100 gallons of paint.

Paint compositions comprising calcined kaolin and optionally at least one ingredient chosen from thickeners, dispersants, and biocides, as described herein, may additionally comprise at least one additional ingredient chosen from a polymeric binder, a primary pigment such as titanium dioxide, a secondary pigment such as calcium carbonate, silica, nephaline syenite, feldspar, dolomite, diatomaceous earth, and flux-calcined diatomaceous earth. For water-based versions of such paint compositions, any water-dispersible binder, such as polyvinyl alcohol (PVA) and acrylics may be used. Paint compositions of the present invention may also comprise other conventional additives, including, but not limited to, surfactants, thickeners, defoamers, wetting agents, dispersants, solvents, and coalescents.

Calcined kaolin compositions of the present disclosure may confer desirable properties on compositions comprising them. As flattening (or matting) agents, they may help to control the gloss and sheen of the surfaces of the substrates to which they are applied. One embodiment of the disclosure includes a paint or coating composition comprising a second composition comprising a calcined kaolin having a mean particle size (d₅₀) of at least about 2 μm, and a Na₂O content of less than about 1% by weight, relative to the total weight of the second composition. In another embodiment, the second composition is a flattening agent in the paint or coating composition.

As opacifiers, calcined kaolins impart brightness, whiteness, and other desirable optical properties. As extenders, they allow partial replacement of titanium dioxide and other more expensive pigments with minimal loss of whiteness or opacity. For example, increased opacity in high PVC paints comprising calcined kaolins can be the result of greater resin demand. The extender material can be used in paper, polymers, paints and the like or as a coating pigment or color ingredient for coating of paper, paper board, plastic papers and the like.

The calcined kaolin products of the present disclosure can be used in coating compositions in which any one of these characteristics are desired. In one embodiment, the calcined kaolin is a component of a paper coating. Products comprising the disclosed calcined kaolin compositions may also be useful wherever kaolins are used, such as in making filled plastics, rubbers, sealants, cables, ceramic products, cementitious products, and paper products and paper coatings.

The composition according to the present disclosure can be used in the production of all paper grades, from ultra lightweight coated paper to coated or filled board. Paper and paperboard products can comprise a coating, which can improve the brightness and opacity of the finished paper or board.

Paper coatings according to the present disclosure can include, in addition to the calcined kaolin as described above, materials generally used in the production of paper coatings and paper fillers. The compositions can include a binder and a pigment, such as TiO₂. The coatings according to the present disclosure may optionally include other additives, including, but not limited to, dispersants, cross linkers, water retention aids, viscosity modifiers or thickeners, lubricity or calendering aids, antifoamers/defoamers, gloss-ink hold-out additives, dry or wet rub improvement or abrasion resistance additives, dry or wet pick improvement additives, optical brightening agents or fluorescent whitening agents, dyes, biocides, leveling or evening aids, grease or oil resistance additives, water resistance additives and/or insolubilizers.

Any art recognized binder may be used in the present compositions. Exemplary binders include, but are not limited to, adhesives derived from natural starch obtained from a known plant source, for example, wheat, maize, potato or tapioca; synthetic binders, including styrene butadiene, acrylic latex, vinyl acetate latex, or styrene acrylic; casein; polyvinyl alcohol; polyvinyl acetate; or mixtures thereof.

Paper coatings have very different binder levels depending upon the type of printing to be used with the coated paper product. Appropriate binder levels based upon the desired end product would be readily apparent to the skilled artisan. Binder levels are controlled to allow the surfaces to receive ink without disruption. The latex binder levels for paper coatings generally range from about 3% to about 30%. In one embodiment, the binder is present in the paper coating in an amount ranging from about 3% to about 10%. In another embodiment, the binder is present in the coating in an amount ranging from about 10% to about 30% by weight.

One embodiment of the present disclosure provides a polymer comprising a composition comprising a calcined kaolin having a mean particle size (d₅₀) of at least about 2 μm, the calcined kaolin having a Na₂O content of less than about 1% by weight, relative to the total weight of the calcined kaolin. The calcined kaolin disclosed herein can be used for resin extension (i.e., filling), TiO₂ extension, and reinforcement of the polymer. In one embodiment, the polymer product can be a highly filled polymer such as a cultured marble. In another embodiment, the polymer product can be a plastic. In a further embodiment, the polymer may be a polymer film. In yet another embodiment, the polymer product can be an adhesive, caulk or sealant. The disclosed polymer product may be useful in reducing surface gloss and as an antiblock to prevent sticking.

The polymer product disclosed herein comprises at least one polymer resin. The term “resin” means a polymeric material, either solid or liquid, prior to shaping into a plastic article. The at least one polymer resin can be one which, on cooling (in the case of thermoplastic plastics) or curing (in the case of thermosetting plastics), can form a plastic material. The at least one polymer resin, which can be used herein, can be chosen, for example, from polyolefin resins, polyamide resins, polyester resins, engineering polymers, allyl resins, thermoplastic resins, and thermoset resins.

In another embodiment, the present disclosure provides a rubber product comprising a composition comprising a calcined kaolin having a mean particle size (d₅₀) of at least about 2 μm, the calcined kaolin having a Na₂O content of less than about 1% by weight, relative to the total weight of the calcined kaolin. The calcined kaolin can provide the benefits of resin extension, reinforcement of the rubber, and increased hardness of the rubber composition. The rubber product disclosed herein comprises at least one rubber chosen from natural rubbers and synthetic rubbers.

One embodiment of the present disclosure provides a method of forming a ceramic body, comprising:
1) combining a calcined kaolin having a mean particle size (d₅₀) of at least about 2 μm, the calcined kaolin having a Na₂O content of less than about 1% by weight, relative to the total weight of the calcined kaolin, with at least one compound selected from alumina, talc and aluminum hydroxide,
2) adding an amount of water and mixing to form a clay comprising the calcined kaolin, and
3) extruding the clay to form the ceramic body.

In one embodiment, the calcined kaolin is combined with alumina, talc and aluminum oxide. In another embodiment, at least one component selected from a binder and a lubricant is added prior to adding the amount of water. Suitable binders include those listed above. An art recognized lubricant may also be used in the disclosed method. The amount of water to be added can be determined by the skilled artisan to arrive at a clay with desired properties, such as a desired viscosity. Mixing may be accomplished by a kneading machine, for example. Extruding the clay may involve the use of an art-recognized molding machine. The form of the extruded ceramic body may be, for example, a rod or a cellular shape.

In one embodiment, the extruding comprises a forming method commonly used in the production of complex ceramic objects, such as intricate honeycomb ceramics used as substrate supports in catalytic converters. One skilled in the art will recognize that extrusion may be carried out in a number of different ways, such as, for example, the methods disclosed in U.S. Pat. No. 3,885,977 to Lachman, U.S. Pat. No. 5,332,703 to Hickman et al., or U.S. Pat. No. 5,997,984 to Koike et al., the disclosures related to such methods are herein incorporated by reference.

In one embodiment, the extruded ceramic body has a honeycomb structure. In a further embodiment, the extruded ceramic body is a catalyst substrate. In another embodiment, a composition comprising a calcined kaolin as disclosed herein is used to form cordierite, a magnesium alumina silicate. Cordierite is known for properties such as a low coefficient of thermal expansion, high thermal shock resistance, volume resistivity, and good electrical insulation properties. Another embodiment provides a catalyst substrate comprising the cordierite. In addition to catalyst substrates, the cordierite may be used in manufacturing kiln furniture, among other products, due to its thermal shock resistance.

Catalytic converters using the disclosed catalyst substrates may be used for modifying the emissions from fossil fuel based power sources, including, but not limited to, gasoline engines and diesel engines. The large mean particle size of the disclosed calcined kaolin may be useful in the larger catalyst substrates employed in catalytic converters for diesel engines. The low level of alkali and alkali earth metal oxides may increase the performance of catalyst substrates comprising the disclosed calcined kaolin. Even small amounts of alkali or alkali earth metals may lead to undesirable properties in conventional catalyst substrates, such as decreasing the number of NO₂ adsorption sites, increasing the coefficient of thermal expansion and generally weakening the structural properties of the ceramic.

Another embodiment of the present disclosure provides a method of forming a ceramic body, comprising:
a) adding a liquid medium to a composition comprising a calcined kaolin having a mean particle size (d₅₀) of at least about 2 μm, the calcined kaolin having a Na₂O content of less than about 1% by weight, relative to the total weight of the calcined kaolin, to form a calcined kaolin slurry;
b) flocculating the calcined kaolin slurry;
c) dewatering the calcined kaolin slurry to obtain a calcined kaolin wet cake; and
d) forming the calcined kaolin wet cake into a ceramic body.

In one embodiment, the calcined kaolin slurry in a) further comprises at least one mineral chosen from hydrous kaolin, talc, halloysite, calcium carbonate, gypsum, feldspar, silica, and nepheline syenite. In another embodiment, the method of forming the slurry further comprises adding a biocide to the calcined kaolin slurry.

The calcined kaolin slurry may also be screened by blunging the calcined kaolin with water to form an aqueous suspension. In one embodiment, the slurry further comprises at least one dispersant. The at least one dispersant can be present in an amount effective to fluidize the slurry, for example in an amount ranging from about 0.01% to about 2% by weight, relative to the total weight of the slurry, such as an amount ranging from about 0.01% to about 1% by weight.

In one embodiment, a dispersing agent is added to the slurry before flocculation, resulting in a pH that is greater than or equal to about 6.5, such as a pH ranging from about 8 to about 10. To achieve the desired pH, the slurry can further comprise at least one water-soluble pH modifier. Non-limiting examples of suitable pH-modifiers include sodium carbonate, ammonium carbonate, amino-2-methyl-1-propanol, sodium silicate, sodium hydroxide, and ammonium hydroxide. In some embodiments, the non-alkali metal salts may be selected to reduce the overall alkali metal content of the product.

Dispersing agents may also be chosen from art recognized organic polymeric dispersants that are traditionally used in kaolin-containing compositions. Appropriate dispersants will be readily apparent to the skilled artisan. For example, dispersants may be chosen from polyelectrolytes such as polyacrylates and copolymers comprising polyacrylate species, for example polyacrylate salts (such as sodium, ammonium and potassium salts), sodium hexametaphosphates, polyphosphoric acid, condensed sodium phosphate, alkanolamines, and other reagents commonly used for this function. Other non-limiting examples of suitable dispersants include 2-amino-2-methyl-1-propanol, tetrasodium pyrophosphate, trisodium phosphate, tetrasodium phosphate, sodium tripolyphosphate, sodium silicate, sodium carbonate, sodium or potassium salts of weak acids, such as condensed naphthalene sulfonic acid and polymeric carboxylic acid, and water-soluble organic polymeric salts, such as sodium or ammonium polyacrylate, and polymethacrylates such as sodium or ammonium polymethacrylate.

The fluid calcined kaolin slurry may then flocculated in b), typically by lowering the pH of the fluid calcined kaolin slurry to less than or equal to about 5, such as less than or equal to about 4. This downward pH adjustment can be accomplished by simply adding an appropriate amount of an acid, such as for example sulfuric acid, alum or other suitable acid.

In one embodiment, the flocced calcined kaolin slurry may be dewatered in c) by one of the ways well known in the art, e.g., filtration such as via rotary filter or filter press, centrifugation, evaporation and the like, provided that the slurry has a moisture content of greater than or equal to about 10%, such as about 15% or about 20%, at all points between the flocculating and forming processes. Dewatering can also be accomplished with a filter press. Whatever the process, it is understood that the calcined kaolin is not dried to a moisture content of less than about 10%, less than about 15%, or even less than about 20%, at any time between screening and forming.

In one embodiment, the forming in d) comprises at least one method chosen from casting, rolling, extruding, pressing, and molding the calcined kaolin wet cake.

In one embodiment, the method allows formation of cast ceramic ware product comprising the ceramic body, or formation of an extruded ceramic body comprising the ceramic body. Even further disclosed herein are ceramic body filter cakes, greenware products, and catalyst substrates comprising the ceramic bodies as described herein.

Slip casting is typically used in production of products having complex shapes and where plastic forming or semi-dry pressing are not possible. Thus, slip casting is applicable to the production of, for example, hollow tableware, figures and ornamental ware, and sanitary ware. For whiteware production, ‘jiggering’ can also be used to produce ware. Slip casting involves the use of a mold of appropriate shape into which a fluid suspension of a ceramic body can be poured and wherein the mold progressively extracts some of the water until a solid layer is formed.

Two primary methods are typically employed for slip casting: drain casting and solid casting. In drain casting, a mold is filled with slip and casting takes place on one surface only. After a suitable time, during which the desired cast thickness is built up, the excess slip is poured off. The mold and cast are then partially dried to allow mold release, after which the cast can be trimmed, cut or sponged. In solid casting, which is typically used for products having varying wall thicknesses, the mold is filled with slip and casting takes place on both surfaces. The removal of water generally means that the slip has to be topped up during the casting. For complex shapes, the mold can be constructed in several sections.

In one embodiment, the forming in d) comprises slip casting the calcined kaolin wet cake into a ceramic body. The disclosed calcined kaolin may serve as a useful component in casting slips due to the low proportion of small particles, e.g., particles with a d₅₀ less than 2 μm.

One embodiment of the present disclosure provides a method of forming a ceramic body using dry calcined kaolin to cast the ceramic body. In another embodiment, the dry calcined kaolin may be a substitute for a calcined kaolin wet cake as disclosed above. The disclosed calcined kaolin in dry form may be useful in slip or drain casting processes.

The present disclosure is further illustrated by the following non-limiting examples, which are intended to be purely exemplary of the disclosure.

### EXAMPLES

### Example 1

### Optical and Physical Properties of Calcined Kaolins

Inventive Samples A, B, C and D were prepared by calcining crude hydrous kaolin (starting materials A-D) at 1050° C. for 1 h. Table 1 illustrates the optical and size properties of inventive samples A, B, C and D. The corresponding properties for the crude hydrous kaolin starting materials (SM-A to SM-D) are provided for each sample.

The brightness (“Bri”) given in Table 1 is the GE brightness as measured by a Technibrite TB-1C instrument. Components a, b, and L are the color component values on the color space scale as measured by a Technibrite TB-1C instrument. “+a” is a measure of red tint; “−a” is a measure of green tint; “+b” is a measure of yellow tint; “−b” is a measure of blue tint; “L” is a measure of whiteness.

As shown in Table 1, oil absorption (“oil abs”) is the number of grams of oil absorbed by 100 grams of calcined kaolin (units of g/g, indicated as a %). The oil absorption was measured by the Spatula Rub-out Oil Absorption Test (ASTM-D-281). The +325 residue content reflects the percentage by weight of particles that were retained on a 325 mesh screen.

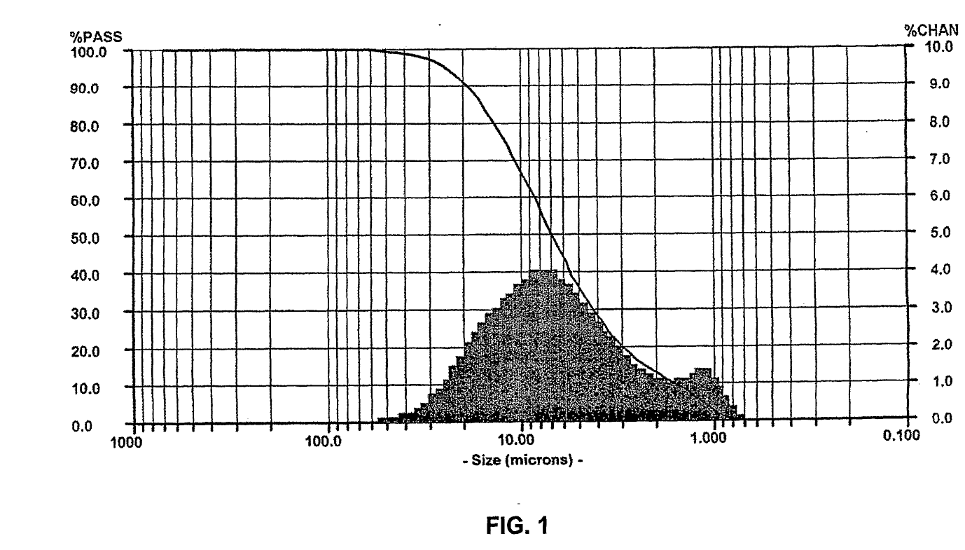

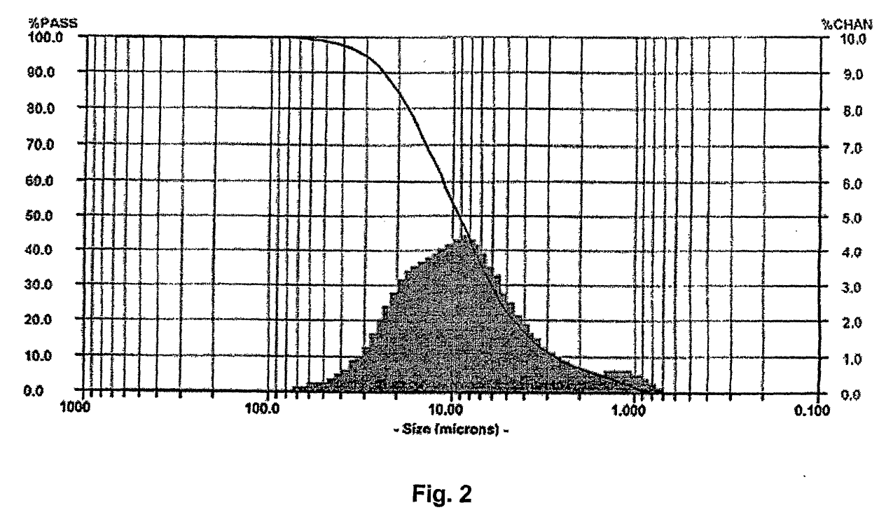

The mean particle-size based on particle volume (mv, μm) as determined by Microtrac Model X100 Particle Size Analyzer, which determines particle size by a laser light scattering technique, is shown in Table 2 for inventive samples A-D. FIG. 1, corresponding to sample A, is a plot of particle size (mv, μm) vs. the percentage of particles by weight below the noted particle size (% PASS), shown as a line graph. FIGS. 2, 3 and 4 illustrate the corresponding particle size data for samples B, C and D, respectively.

Table 2 also gives the percentage by weight of calcined kaolin particles that have a particle size less than the indicated size in μm, as determined using a SEDIGRAPH-5100 instrument obtained from Micromeritics Corporation, USA. The “Med Dia” indicates the mean particle size in μm for each sample.

TABLE 1

| Sample | Bri | L | a | b | oil abs | +325 Residue |
|---|---|---|---|---|---|---|
| SM-A | 83.06 | 93.61 | 0.11 | 4.08 | — | — |
| A | 89.19 | 95.51 | −0.39 | 2.14 | 54.6 | 0.066% |
| SM-B | 75.73 | 90.46 | 0.44 | 5.41 | — | — |
| B | 81.53 | 92.27 | −0.01 | 3.39 | 48.6 | 0.495% |
| SM-C | 83.22 | 93.29 | 0.11 | 3.51 | — | — |
| C | 86.27 | 93.95 | −0.16 | 2.13 | 73.8 | 0.561% |
| SM-D | 82.51 | 93.39 | 0.15 | 4.18 | — | — |
| D | 89.79 | 96.44 | −0.36 | 3.03 | 53.6 | 0.038% |

TABLE 2

| | mv | % < | % < | % < | % < | % < | % < | Med |
|---|---|---|---|---|---|---|---|---|
| Sample | (μm) | 20 | 10 | 5 | 2 | 1 | 0.5 | Dia |
| SM-A | | 98.7 | 85.7 | 56.1 | 30.8 | 22.4 | 13.9 | 4.25 |
| A | 9.207 | 98.4 | 87.1 | 57.5 | 25.9 | 13.0 | 2.6 | 4.23 |
| SM-B | | 94.1 | 69.9 | 31.4 | 11.4 | 6.4 | 2.5 | 7.12 |
| B | 12.08 | 92.6 | 66.0 | 26.7 | 7.3 | 2.3 | −1.2 | 7.71 |
| SM-C | | 96.5 | 85.1 | 54.2 | 14.8 | 7.2 | 4.0 | 4.67 |
| C | 12.61 | 96.8 | 84.7 | 50.8 | 9.9 | 2.5 | −0.7 | 4.94 |
| SM-D | | 99.0 | 85.5 | 51.7 | 21.0 | 11.9 | 6.4 | 4.83 |
| D | 8.719 | 98.2 | 87.2 | 55.5 | 21.5 | 9.8 | 2.6 | 4.48 |

Table 1 illustrates the increase in brightness and whiteness of the inventive samples over their starting materials. Good oil absorption and a low level of +325 mesh residue was also observed. As shown in Table 2, a decrease in the percentage of particles less than 2 μm was observed in each of inventive samples A-D. Samples B and C also showed an increase in mean particle diameter compared to SM-B and SM-C, respectively.

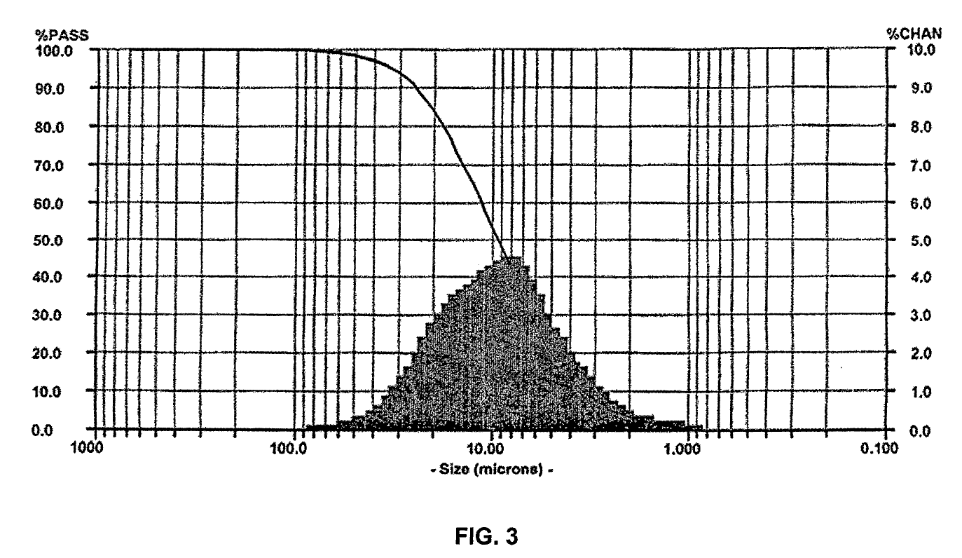

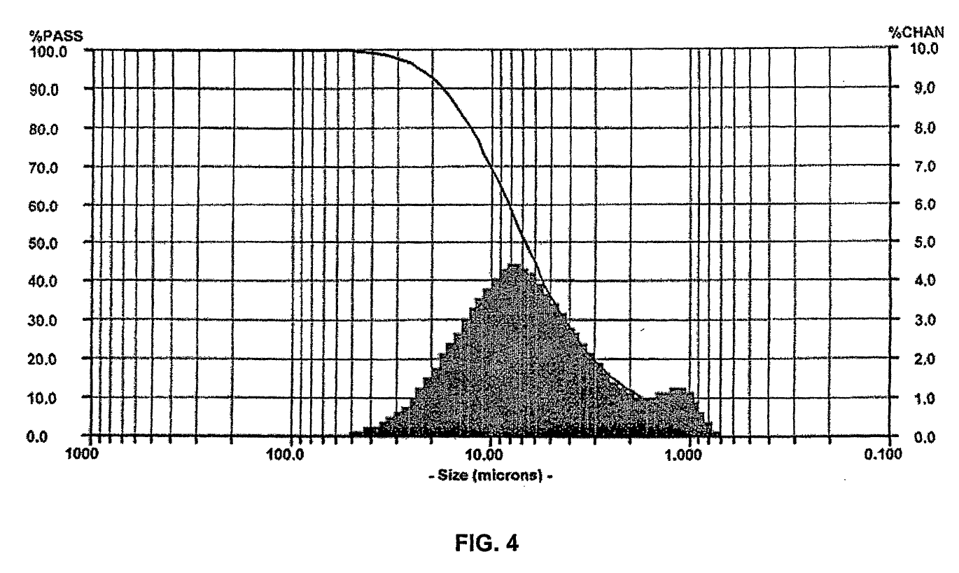

In Table 2, the “mv” and “Med. Dia.” data indicates that inventive samples A-D fall within the range of at least about 2 μm when determined by both Microtrac Model X100 Particle Size Analyzer and SEDIGRAPH 5100, respectively. FIGS. 1 and 4 show a bimodal particle size distribution, while FIGS. 2 and 3 depict a unimodal distribution.

### Example 2

### Relative Porosity of Calcined Kaolins

As shown in Table 3, the relative porosity of inventive samples C and D was determined by a Baroid® Filter Assay using a Baroid® High Pressure Filter Press. A known weight of calcined kaolin was used to form a slurry column containing 40% solids. The Baroid® High Pressure Filter Press applied compressed air pressure to the top of a slurry column, which was resting on a filter disk. Application of the pressure forced the filtrate through the filter, which was then collected and measured in mL's released at the given time points and finally at blowout. The calcined kaolin formed a filter cake on the filter, which was weighed. The cake solids, as a percentage by weight of the filter cake, was calculated using the known dry weight of the calcined kaolin.

TABLE 3

| mL's released | | | | | | | | |
|---|---|---|---|---|---|---|---|---|
| | ″@1 | @3 | @5 | @10 | | Total | | Cake |
| Sample | min | min | min | min | @blow | Time | | Solids |
| C | 36.3 | 77.1 | 106.5 | — | 140.5 | 7.8 | min | 61.7% |
| D | 40.3 | 76.2 | 100.1 | 146.2 | 175.5 | 13.6 | min | 71.2% |

When temperature and pressure are held constant, the time required for a certain quantity of filtrate to be collected is a good measure of ease of filtration. Relative porosity is generally inversely related to the time to blowout. The total time elapsed to blowout for samples C and D demonstrates good relative porosity. Higher porosity could allow a higher flow rate of water through the calcined kaolin, which may lead to an increased casting rate.

### Example 3

### Comparative Dispersion, Gloss and Sheen of Calcined Kaolins

A comparative dispersion test of control sample E, Neogen EFP commercially available from Imerys, and inventive samples A and B was conducted using the “SSM” V-T Alkyd Hegman Test. In the dispersion test, a simulated sand mill was used for grinding. Specifically, approximately 250 g of glass beads, Potters Industries A-Series, Tech Quality Glass Spheres, A-205 (nominal 2 mm diameter) were added to a 500 ml HDPE screw-top cylindrical sample bottle, along with nominally the same weight of the final formulation. The calcined kaolin-containing mixture then underwent grinding using a mechanical agitator, Red Devil Model 5400 Paint Shaker for certain period of time (grind time) as specified. Dispersion was measured as a function of time using a standard Hegman Grind gauge with Hegman National Standard ranging from 0 to 8, wherein the higher number of the Hegman Grind value, the higher the relative degree of dispersion. The Hegman Grind value for samples E, A and B remained unchanged (from 5.00) up to grind times of 15 minutes.

Gloss and sheen properties for samples E, A and B at 1, 5, 10, and 15 minutes of grinding were measured in a known manner using a Hunter Pro-3 Gloss Meter, as shown in Table 4.

TABLE 4

| | Sample | | |
|---|---|---|---|
| | E | A | B |
| 1 MIN GRIND | | | |
| 20 Deg Gloss | 18.6 | 22.9 | 20.3 |
| 60 Deg Gloss | 63.4 | 64.9 | 59.6 |
| 85 Deg Sheen | 83.7 | 79.4 | 71.5 |
| 5 MIN GRIND | | | |
| 20 Deg Gloss | 18.7 | 21.9 | 18.7 |
| 60 Deg Gloss | 62.2 | 63.1 | 57.8 |
| 85 Deg Sheen | 81.9 | 78.7 | 71.3 |
| 10 MIN GRIND | | | |
| 20 Deg Gloss | 18.7 | 23.9 | 17.3 |
| 60 Deg Gloss | 62.2 | 65.7 | 55.6 |
| 85 Deg Sheen | 83.2 | 81.2 | 69.4 |
| 15 MIN GRIND | | | |
| 20 Deg Gloss | 18.3 | 23.0 | 17.3 |
| 60 Deg Gloss | 62.4 | 64.5 | 55.6 |
| 85 Deg Sheen | 83.7 | 80.3 | 69.5 |

The data from Table 4 indicates that gloss and sheen levels are generally retained upon grinding for up to 15 minutes. Overall, inventive samples A and B have good anti-dispersion properties. The dispersion attained after 1 minute of grinding is comparable to the dispersion measured after 15 minutes of grinding, illustrating the relatively high degree of dispersability of the inventive compositions.

### Example 4

### Optical Properties of 65% PVC Paint Film Comprising Calcined Kaolins

As shown in Table 5, optical properties of 65% PVC paint film comprising control sample F, Neogen FTE commercially available from Imerys, and inventive samples A and B were determined, including 600 Gloss, 850 Sheen, and the color component values a, b, and L on the color space scale. Gloss and sheen were measured using a Hunter Pro-3 Gloss Meter. Color values (L, a, b) were measured using a Hunter Ultrascan XE Instrument as disclosed herein. ASTM-E-313 white and yellow are standard measurements, made using a Hunter Ultrascan XE Instrument, of the whiteness and yellowness of near white, opaque film coatings.

Tint strength is a measure of the overall color response to the addition of colorants. Tint strength can be related to the magnitude of ΔE, which is defined below:

ΔE=(ΔL²+Δa²+Δb²)^{1/2}

Opacity and 457 brightness were measured using a Hunter Ultrascan XE Instrument. Pigment color and particle size data for the control sample F was also determined.

TABLE 5

| | Sample | | |
|---|---|---|---|
| | F | A | B |
| | (control) | (inventive) | (inventive) |
| 60 Deg Gloss | 3.0 | 3.0 | 3.0 |
| 85 Deg Sheen | 8.0 | 10.0 | 7.9 |
| Untinted | | | |
| L | 95.16 | 95.14 | 94.77 |
| a | −0.75 | −0.77 | −0.73 |
| b | 1.71 | 1.40 | 1.55 |
| Opacity (Y) | 96.76 | 95.64 | 95.61 |
| WI E313(2/C) | 82.69 | 84.06 | 82.65 |
| YI E313(2/C) | 2.75 | 2.14 | 2.47 |
| 457 Brightness | 88.62 | 88.99 | 88.09 |
| Tinted | | | |
| L | 78.86 | 78.09 | 77.50 |
| a | −9.79 | −10.02 | −10.16 |
| b | −17.61 | −18.65 | −18.93 |
| Delta E | 0.00 | 1.31 | 1.93 |
| Delta L | 0.00 | 0.77 | 1.36 |
| Delta a | 0.00 | 0.23 | 0.37 |
| Delta b | 0.00 | 1.04 | 1.32 |
| Pigment Data | | | |
| Whiteness | 83.06 | | |
| Yellowness | 3.21 | | |
| Brightness | 93.07 | | |
| L | 97.61 | | |
| a | −0.20 | | |
| b | 2.17 | | |
| Oil abs | 91 | | |
| SEDIGRAPH | | | |
| % < 10 μm | 97 | | |
| % < 5 μm | 85 | | |
| % < 2 μm | 56 | | |
| % < 1 μm | 37 | | |
| % < 0.5 μm | 8 | | |
| BET | | | |
| MED. DIAM | 1.55 | | |

The data in Table 5 indicates the utility of the inventive materials in low gloss, low sheen paint compositions.

### Example 5

### Chemical Purity of Calcined Kaolins

The chemical purity of inventive samples A, B and C and their respective starting materials was assessed by determining the amount of the metal oxides and elements given in Tables 6 and 7. Amounts are given as a percentage by weight, relative to the total weight of the composition. The amount of a given metal oxide or element was determined by X-ray fluorescence spectroscopy using a Bruker SRS 3000 X-ray Fluorescence Spectrometer.

Table 6 shows that the percentage of particles having a particle size less than 2 microns and less than 1 micron are both reduced for each of inventive samples A, B and C over their corresponding starting materials. For the percentage of particles less than 1 micron, the amount present in the inventive samples has decreased to about half that of the corresponding starting material. Coupled with this reduction in particles less than 2 microns in size, the combined level of alkali and alkali earth metal oxides present in the composition is less than about 1% for each inventive sample. In particular, the Na₂O level is less than about 0.01% and the K₂O level is less than about 0.5% in each inventive sample. Compared to the starting material samples, the increase in GE brightness and decrease in moisture and residue levels seen in the inventive samples exemplifies the benefits conferred by the inventive composition's particle size and chemical purity characteristics.

In Table 6, the particle size of inventive samples A, B and C were determined using a SEDIGRAPH 5100 instrument. The particle size of the A, B and C starting materials was determined by both SEDIGRAPH 5100 and a Microtrac Model X100 Particle Size Analyzer. The GE brightness was measured by a Technibrite TB-1C instrument. The +325 and +150 mesh residue measurements reflect the percentage by weight of particles that were retained on a 325 mesh and 150 mesh screen, respectively. The pH, moisture, and surface area data were determined using known methods in the art.

Table 7 provides the percentage amounts of the major components in the inventive samples. As in Table 6, Table 7 shows that the combined level of alkali and alkali earth metals in samples A, B and C is less than about 1%, with each sample having a Na₂O level less than about 0.1% and a K₂O level less than about 0.5%.

TABLE 6

| | | Sample | | | | | |
|---|---|---|---|---|---|---|---|
| | | SM-A | A | SM-B | B | SM-C | C |
| | G.E. | 83.2 | 89.6 | 76.0 | 82.0 | 83.3 | 86.8 |
| | Brightness | | | | | | |
| | pH | 4.3 | 5.1 | 4.6 | 5 | 4.4 | 4.5 |
| | Moisture | 0.7 | 0.2 | 0.8 | 0.2 | 0.8 | 0.2 |
| Residue | % + 150 | 0.0009 | 0.0004 | 0.0048 | 0.0009 | 0.0012 | 0.0009 |
| | % + 325 | 0.0887 | 0.0422 | 0.7420 | 0.3513 | 0.7328 | 0.5286 |
| | Surface Area | | 6.18 | | 4.39 | | 4.42 |
| SEDIGRAPH | % < 10μ | 82.5 | 80.9 | 68.6 | 69.0 | 84.2 | 86.0 |
| | % < 2μ | 31.0 | 22.4 | 13.1 | 9.7 | 15.4 | 12.3 |
| | % < 1μ | 22.3 | 10.6 | 8.7 | 4.4 | 8.4 | 4.3 |
| Microtrac | % < 10 (10.09μ) | 60.4 | | 47.7 | | 47.6 | |
| | % < 2 (1.945μ) | 10.7 | | 5.9 | | 2.4 | |
| | % < 1 (0.972μ) | 2.6 | | 1.5 | | 0 | |
| | % Fe₂O₃ | 0.371 | 0.421 | 0.322 | 0.364 | 0.348 | 0.412 |
| | % TiO₂ | 0.669 | 0.774 | 0.823 | 0.947 | 0.501 | 0.602 |
| | % CaO | 0.013 | 0.015 | 0.002 | 0.004 | 0.007 | 0.010 |
| | % K₂O | 0.160 | 0.185 | 0.156 | 0.170 | 0.423 | 0.484 |
| | % MgO | 0.053 | 0.082 | 0.046 | 0.076 | 0.059 | 0.099 |
| | % Na₂O | 0.058 | 0.064 | 0.033 | 0.042 | 0.075 | 0.090 |

TABLE 7

| | Sample | | |
|---|---|---|---|
| | A | B | C |
| % Al₂O₃ | 47.25 | 48.27 | 46.94 |
| % K₂O | 0.16 | 0.15 | 0.42 |
| % MgO | 0.09 | 0.09 | 0.12 |
| % SiO₂ | 50.85 | 51.64 | 52.05 |
| % Na₂O | <0.06 | <0.06 | 0.06 |
| % Fe₂O₃ | 0.33 | 0.29 | 0.32 |
| % TiO₂ | 0.66 | 0.87 | 0.50 |
| % P₂O₃ | <0.10 | <0.10 | <0.10 |
| % CaO | 0.03 | 0.02 | 0.03 |
| % Ba | <0.03 | <0.03 | <0.03 |
| % S | <0.01 | <0.01 | <0.01 |
| % LOI¹ | 0.34 | 0.32 | 0.33 |
| % Total | 99.72 | 101.64 | 100.77 |

¹LOI referes to loss on ignition.

Unless otherwise indicated, all numbers expressing quantities of ingredients, reaction conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present disclosure.

Other embodiments of the disclosure will be apparent to those skilled in the art from consideration of the specification and practice of the embodiments disclosed herein. It is intended that the specification and examples be considered as exemplary only, with a true scope and spirit of the disclosure being indicated by the following claims.

1: A composition comprising a calcined kaolin having a mean particle size (d₅₀) of at least about 2 μm, the calcined kaolin having a Na₂O content of less than about 1% by weight, relative to the total weight of the calcined kaolin.

2: The composition of claim 1, wherein the d₅₀ is determined from a mass distribution of particles.

3: The composition of claim 2, wherein the d₅₀ is at least about 3 μm.

4. (canceled)

5: The composition of claim 3, wherein the d₅₀ is at least about 5 μm.

6: The composition of claim 5, wherein the d₅₀ is at least about 10 μm.

7. (canceled)

8: The composition of claim 6, wherein the d₅₀ is at least about 20 μm.

9: The composition of claim 1, wherein the d₅₀ is determined from a number distribution of particles.

10: The composition of claim 9, wherein the d₅₀ is at least about 7 μm.

11. (canceled)

12: The composition of claim 10, wherein the d₅₀ is at least about 12 μm.

13: The composition of claim 1, wherein less than about 25% of the particles have a particle size less than about 1 μm.

14: The composition of claim 1, wherein the Na₂O content is less than about 0.6% by weight, relative to the total weight of the calcined kaolin.

15. (canceled)

16: The composition of claim 14, wherein the Na₂O content is less than about 0.1% by weight, relative to the total weight of the calcined kaolin.

17: The composition of claim 16, wherein the Na₂O content is less than about 0.05% by weight, relative to the total weight of the calcined kaolin.

18: The composition of claim 1, wherein the calcined kaolin has a combined Na₂O, K₂O, MgO, and CaO content less than about 1% by weight, relative to the total weight of the calcined kaolin.

19. (canceled)

20: The composition of claim 18, wherein combined Na₂O, K₂O, MgO, and CaO content is less than about 0.5% by weight, relative to the total weight of the calcined kaolin.

21: The composition of claim 20, wherein the combined Na₂O, K₂O, MgO, and CaO content is less than about 0.3% by weight, relative to the total weight of the calcined kaolin.

22: The composition of claim 1, wherein the calcined kaolin has a K₂O content less than about 0.5% by weight, relative to the total weight of the calcined kaolin.

23: The composition of claim 22, wherein the K₂O content is less than about 0.25% by weight, relative to the total weight of the calcined kaolin.

24: The composition of claim 1, wherein the calcined kaolin has a Fe₂O₃ content less than about 1% by weight, relative to the total weight of the calcined kaolin.

25: The composition of claim 24, wherein the Fe₂O₃ content is less than about 0.5% by weight, relative to the total weight of the calcined kaolin.

26: The composition of claim 1, wherein the calcined kaolin has a TiO₂ content less than about 2% by weight, relative to the total weight of the calcined kaolin.

27: The composition of claim 26, wherein the TiO₂ content is less than about 1% by weight, relative to the total weight of the calcined kaolin.

28: The composition of claim 1, wherein the calcined kaolin has a mullite content of at least about 2% by weight, relative to the total weight of the calcined kaolin.

29: The composition of claim 28, wherein the mullite content is at least about 5% by weight, relative to the total weight of the calcined kaolin.

30: The composition of claim 29, wherein the mullite content is at least about 10% by weight, relative to the total weight of the calcined kaolin.

31: The composition of claim 1, wherein the calcined kaolin has one of a unimodal, a bimodal, or a multimodal particle size distribution when determined using a Microtrac Model X100 Particle Size Analyzer.

32. (canceled)

33. (canceled)

34: The composition of claim 1, wherein an amount of residue in the calcined kaolin that is retained by a 325 mesh screen is less than about 1% by weight, relative to the total weight of the calcined kaolin.

35: The composition of claim 34, wherein the amount of residue is less than about 0.6% by weight, relative to the total weight of the calcined kaolin.

36: The composition of claim 35, wherein the amount of residue is less than about 0.1% by weight, relative to the total weight of the calcined kaolin.

37: The composition of claim 36, wherein the amount of residue is less than about 0.05% by weight, relative to the total weight of the calcined kaolin.

38: The composition of claim 1, wherein the calcined kaolin has an oil absorption of at least about 40% by weight, relative to the total weight of the calcined kaolin.

39. (canceled)

40: The composition of claim 38, wherein the oil absorption is at least about 60% by weight, relative to the total weight of the calcined kaolin.

41: The composition of claim 40, wherein the oil absorption is at least about 70% by weight, relative to the total weight of the calcined kaolin.

42: The composition of claim 1, wherein the composition has a GE brightness of at least about 70%.

43: The composition of claim 42, wherein the GE brightness is at least about 80%.

44: The composition of claim 1, wherein the calcined kaolin has less than about 25% of the particles having a particle size less than about 1 μm.

45: The composition of claim 44, wherein less than about 10% of the particles have a particle size less than about 1 μm.

46: The composition of claim 45, wherein less than about 5% of the particles have a particle size less than about 1 μm.

47: The composition of claim 46, wherein less than about 3% of the particles have particle size less than about 1 μm.

48: The composition of claim 44, wherein the calcined kaolin has less than 25% of the particles having a particle size less than about 0.5 μm.

49: The composition of claim 44, wherein the Na₂O content is less than about 0.6% by weight, relative to the total weight of the calcined kaolin.

50. (canceled)

51: The composition of claim 49, wherein the Na₂O content is less than about 0.1% by weight, relative to the total weight of the calcined kaolin.

52: The composition of claim 51, wherein the Na₂O content is less than about 0.05% by weight, relative to the total weight of the calcined kaolin.

53: A method of preparing a composition comprising: heating a hydrous kaolin having a Na₂O content of less than about 1% by weight, relative to the total weight of the hydrous kaolin, to at least one temperature ranging from about 500° C. to about 1200° C. for a time sufficient to at least partially dehydroxylate the hydrous kaolin to form the composition, wherein the composition comprises an at least partially calcined kaolin having a mean particle size (d₅₀) of at least about 2 μm, the at least partially calcined kaolin having a Na₂O content of less than about 1% by weight, relative to the total weight of the at least partially calcined kaolin.

54: The method of claim 53, wherein the d₅₀ is at least about 3 μm.

55. (canceled)

56: The method of claim 54, wherein the d₅₀ is at least about 5 μm.

57: The method of claim 56, wherein the d₅₀ is at least about 10 μm.

58. (canceled)

59: The method of claim 57, wherein the d₅₀ is at least about 20 μm.

60: The method of claim 53, wherein the at least partially calcined kaolin has less than about 25% of the particles having a particle size less than about 1 μm.

61: The method according to claim 53, wherein the heating occurs for a time sufficient to fully dehydroxylate the hydrous kaolin.

62: The method of claim 53, wherein the heating comprises soak calcining.

63: The method of claim 53, wherein the heating comprises flash calcining.

64: The method of claim 53, wherein the composition comprises fully calcined kaolin.

65: The method of claim 53, wherein the composition comprises partially calcined kaolin.

66: A paint composition, a coating composition, a polymer product, or a rubber product comprising the composition of claim 1.

67: The paint or coating composition of claim 66, wherein the calcined kaolin is a flattening agent in the paint or coating composition.

68: The paint or coating composition of claim 67, wherein the calcined kaolin is an opacifying agent in the paint or coating composition.

69. (canceled)

70: The polymer product of claim 66, wherein the polymer product is selected from a cultured marble, a plastic, a polymer film, an adhesive, a caulk and a sealant.

71. (canceled)

72: A ceramic body comprising a composition comprising a calcined kaolin having a mean particle size (d₅₀) of at least about 2 μm, the calcined kaolin having a Na₂O content of less than about 1% by weight, relative to the total weight of the calcined kaolin.

73: A method of forming a ceramic body, comprising:
1) combining a calcined kaolin having a mean particle size (d₅₀) of at least about 2 μm, the calcined kaolin having a Na₂O content of less than about 1% by weight, relative to the total weight of the calcined kaolin, with at least one compound selected from alumina, talc and aluminum oxide,
2) adding an amount of water and mixing to form a clay comprising the calcined kaolin, and
3) extruding the clay to form the ceramic body.

74: The method of claim 73, wherein the calcined kaolin is combined with alumina, talc and aluminum hydroxide.

75: The method of claim 73, comprising adding at least one component selected from a binder and a lubricant prior to adding the amount of water.

76: The method of claim 75, wherein a binder and a lubricant are added.

77: The method of claim 73, wherein the ceramic body has one of a rod shape or a cellular shape.

78. (canceled)

79: The method of claim 77, wherein the ceramic body has a cellular shape and a honeycomb structure.

80: The ceramic body of claim 79, wherein the ceramic body is a catalyst substrate.

81: The catalyst substrate of claim 80, wherein the catalyst substrate comprises cordierite.

82: A catalytic converter comprising the catalyst substrate of claim 80.

83: The catalytic converter of claim 82, wherein the catalytic converter is associated with one of a gasoline engine or a diesel engine.

84. (canceled)

85: A method of forming a ceramic body, comprising:
a) adding a liquid medium to a composition comprising a calcined kaolin having a mean particle size (d₅₀) of at least about 2 μm, the calcined kaolin having a Na₂O content of less than about 1% by weight, relative to the total weight of the calcined kaolin, to form a calcined kaolin slurry;
b) flocculating the calcined kaolin slurry;
c) dewatering the calcined kaolin slurry to obtain a calcined kaolin wet cake; and
d) forming the calcined kaolin wet cake into the ceramic body.

86: The method of claim 85, wherein the forming comprises at least one method chosen from casting, rolling, extruding, pressing, and molding the calcined kaolin wet cake.

87: The method of claim 86, wherein the forming comprises slip casting the calcined kaolin wet cake.

88: A cast ceramic ware product or an extruded ceramic body comprising the ceramic body of claim 85.

89. (canceled)

90: A method of forming a ceramic body comprising using a dry calcined kaolin having a mean particle size (d₅₀) of at least about 2 μm, the calcined kaolin having a Na₂O content of less than about 1% by weight, relative to the total weight of the calcined kaolin, to cast the ceramic body.
